(19) United States
(12) Patent Application Publication
(10) Pub. No.: US 2002/0181334 A1
(43) Pub. Date: Dec. 5, 2002

(54) Daily calendar

(76) Inventor: Hiroo Nakano, Kurume-city (JP)

Correspondence Address: JORDAN AND HAMBURG LLP, 122 EAST 42ND STREET, SUITE 4000, NEW YORK, NY, 10168, US

(21) Appl. No.: 10/154,508

(22) Filed: May 23, 2002

(30) Foreign Application Priority Data
May 31, 2001 (JP) 2001-163606

(51) Int. Cl. G04B 19/24; G04B 19/20

(52) U.S. Cl. 368/28; 368/40

(57) ABSTRACT

A date-displaying endless sheet has thirty-one dates consecutively carried thereon in a machine direction of the sheet. A day-displaying endless sheet has days of the week consecutively placed thereon in a machine direction of the sheet. A first pair of inserting rollers is rotated to feed the date-displaying sheet to an extent that displays the following date, while a second pair of ejecting rollers is rotated to feed the day-displaying sheet to a level that displays the following day of the week. The above-structured daily calendar is semi-permanently operable without the need for calendar sheet replacement as opposed to prior art reel type calendars.

### BACKGROUND OF THE INVENTION

1. Field of the Invention

This invention relates to a semi-permanently operable daily calendar without the need for removal or replacement of each calendar sheet.

2. Description of the Related Art

One known type of a daily calendar in customary use is hung on the wall, in which each calendar sheet having a date and a day of the week explicitly printed thereon is torn off from a stack of one-year calendar sheets.

However, a problem with the above daily calendar is that a thick calendar having three hundred sixty five sheets stacked by way of a one-year calendar may be bulky and esthetically undesirable to consumers thereof. In order to smooth out the problem, an improved daily calendar as illustrated in FIG. 8 is available. This daily calendar includes a daily calendar sheet-containing roller type cylinder 101 in which a roll of paper having one-year dates and days printed thereon is placed. Each date and day is displayed through an optically transparent guide cover 102 by a leading end of the roll of paper being pulled from the inside of the cylinder 101. Part of paper containing the previous date and day is pulled and torn off from the roll of paper whenever the following date comes, and is then discarded.

FIGS. 9 and 10 illustrate another daily calendar designed to provide semi-permanent displays of months, dates, and days. The daily calendar includes an outer case 103 that is defined with a date window 104 and an information-displaying window 105. A rolled daily calendar sheet 106 having one-year dates and days printed thereon is spirally wound onto a winding reel 107 on a daily basis, thereby displaying the dates and days through the windows 104, 105.

However, the calendar as illustrated in FIG. 8 is a disposable because the roll of paper must be pulled at leading end thereof every day in order to cut off and discard the previous day's paper slip. There is no difference between the above-described calendar and conventional calendars in which a slip of the previous day's paper is torn off every day. In other words, there is a problem that the daily calendar as described above is aesthetically acceptable, but wastepaper must be discarded each time.

One problem with the daily calendar as illustrated in FIGS. 9 and 10 is that very laborious maintenance is required when date, day, and month sheets are provided because the sheets must be rewound at the end of each month, the end of each week, and the end of each year, respectively, although the use of the reel 107 for spirally winding the sheet 106 there around every day eliminates daily discard of wastepaper. Another problem with the daily calendar as shown in FIGS. 9 and 10 is that the outer case 103 must include a space in which the reel 107 is positioned.

The daily calendar as illustrated in FIGS. 9 and 10 has a yet further problem in that attachment and detachment of the sheet 106 is a laborious operation because a new sheet 106 must be installed at the beginning of each year after the sheet 106 wound on the reel 107 is discarded.

### SUMMARY OF THE INVENTION

In order to obviate the above problems, an object of the present invention is to provide a non-disposable daily calendar having a date-displaying endless sheet combined with a day-displaying endless sheet in order to successively rotate the respective sheets.

In order to achieve the above object, a first aspect of the present invention provides a daily calendar including an outer case that is integrally or otherwise individually formed with date and day windows, the outer case including a date-displaying endless sheet consecutively containing thirty-one dates in a machine direction of the sheet in order to expose the dates to the outside through the date window, a day-displaying endless sheet consecutively containing days of the week in a machine direction of the sheet in order to expose the days to the outside through the day window, a first pair of rollers for holding the date-displaying sheet therebetween in a cross-machine direction of the sheet, and a second pair of rollers for holding the day-displaying sheet therebetween in a cross-machine direction of the sheet, wherein the first pair of rollers is rotated to feed the date-displaying sheet to a point that displays the following date, while the second pair of rollers is rotated to feed the day-displaying sheet to a level that displays the following day of the week.

The date- and day-displaying sheets are combined with one another so as to match dates with days. The respective sheets are fed by means of the respective pairs of rollers for holding the respective sheets therebetween in order to feed the sheets. As a result, the date- and day-displaying sheets are advanced to a sufficient degree to display the following date and day, respectively. The above-structured daily calendar is semi-permanently operable without the need for calendar sheet replacement.

The date-displaying sheet is disposed between one pair of side plates, each of which is equal in width to the date-displaying sheet, while the day-displaying sheet is located between another pair of side plates, each of which is equal in width to the day-displaying sheet. As a result, the date- and day-displaying sheets are smoothly fed without being jammed.

A second aspect of the present invention provides a daily calendar including an outer case that is integrally or otherwise individually formed with date and day windows, the outer case including a date-displaying endless sheet consecutively containing thirty-one dates in a machine direction of the sheet in order to expose the dates to the outside through the date window, a day-displaying endless sheet consecutively containing days of the week in a machine direction of the sheet in order to expose the days to the outside through the day window, a first pair of rollers for holding the date-displaying sheet therebetween in a cross-machine direction of the sheet, and a second pair of rollers for holding the day-displaying sheet therebetween in a cross-machine direction of the sheet, wherein a first force-inserting band having a certain width is wrapped around one of the first pair of rollers at a substantially central portion of the roller, while a second force-inserting band having a certain width is wrapped around one of the second pair of rollers at a substantially central portion of the roller, the first and second force-inserting bands being each made of an elastic material, and wherein the first pair of rollers is rotated to feed the date-displaying sheet to a level that displays the following date, while the second pair of rollers is rotated to feed the day-displaying sheet to an extent that displays the following day of the week.

The date- and day-displaying sheets are combined with one another so as to match dates with days. The respective sheets are fed by means of the respective pairs of rollers for holding the respective sheets therebetween in order to feed the sheets. As a result, the date- and day-displaying sheets are advanced to a sufficient extent to display the following date and day, respectively. The above-structured daily calendar is semi-permanently operable without the need for calendar sheet replacement.

The use of the first and second force-inserting bands makes it feasible to smoothly feed the respective sheets without allowing the sheets to be displaced and without allowing the sheets to be forced against respective roller shafts.

### BRIEF DESCRIPTION OF THE DRAWINGS

FIG. 1 is a descriptive illustration, showing the front of a daily calendar according to the present invention by way of illustration;

FIG. 2 is a descriptive illustration, showing the side of the daily calendar;

FIG. 3 is a descriptive illustration, showing a date-displaying sheet for use in the daily calendar;

FIG. 4 is a descriptive illustration, showing a day-displaying sheet for use in the daily calendar;

FIG. 5 is a descriptive illustration, showing an inserting and ejecting roller-interlocking mechanism for use in the daily calendar;

FIG. 6 is a descriptive illustration, showing an essential portion of inserting and ejecting rollers for use in the daily calendar;

FIG. 7 is a descriptive illustration, showing an automatic sheet-feeding means combined with the inserting and ejecting rollers;

FIG. 8 is a descriptive illustration, showing a prior art daily calendar hung on a wall by way of illustration;

FIG. 9 is a descriptive illustration, showing a prior art reel type daily calendar by way of illustration; and

FIG. 10 is a descriptive illustration, showing a winding structure of the prior art reel type daily calendar.

### DETAILED DESCRIPTION OF THE PREFERRED EMBODIMENT

An embodiment of the present invention will now be described in detail with reference to the drawings.

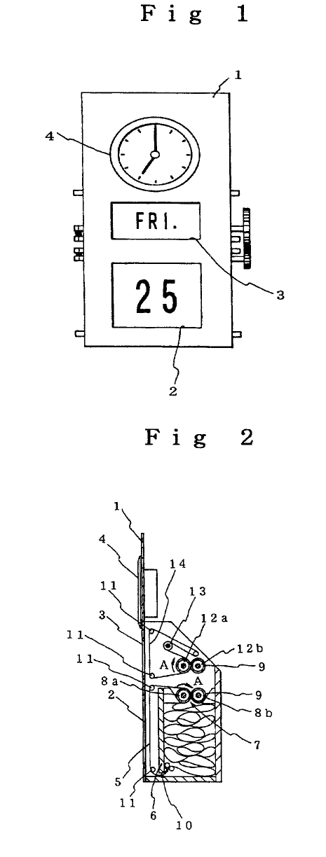

As illustrated in FIG. 1, a date window 2, a day window 3, and a timer 4 are disposed on a front plate of a daily calendar outer case 1 in a state of being vertically arranged in a row in series.

Referring to FIG. 2, a sheet-receiving case 6 is shown disposed behind the date window 2. The sheet-receiving case 6 receives a date-displaying endless sheet 5 having thirty-one dates printed thereon.

The sheet-receiving case 6 includes an inserting opening 7 and a pair of inserting rollers 8a, 8b. The inserting opening 7 is positioned at the top of the case 6 at a substantially central portion thereof. The inserting opening 7 is equal in width to the date-displaying sheet 5. The pair of inserting rollers 8a, 8b are disposed at the opening 7 in such a manner as to form a gap between the rollers 8a, 8b, through which the date-displaying sheet 5 is freely inserted. The inserting roller 8b has a force-inserting band 9 wrapped thereabout. The force inserting band 9 having a certain width and being made of an elastic member such as rubber is positioned at a substantially central portion of the inserting roller 8b.

The sheet-receiving case 6 has an ejecting opening 10 located on the front thereof. The ejecting opening 10 is of a sufficient width to feed the date-displaying sheet 5 through the ejecting opening 10. A pair of bar-like date-displaying sheet guides 11, 11, located on the reverse side of the date window 2, is mounted on the front plate of the outer case 1 at upper and lower positions thereof, respectively.

The sheet-receiving case 6 has an inner width nearly equal to the width of the date-displaying sheet 5.

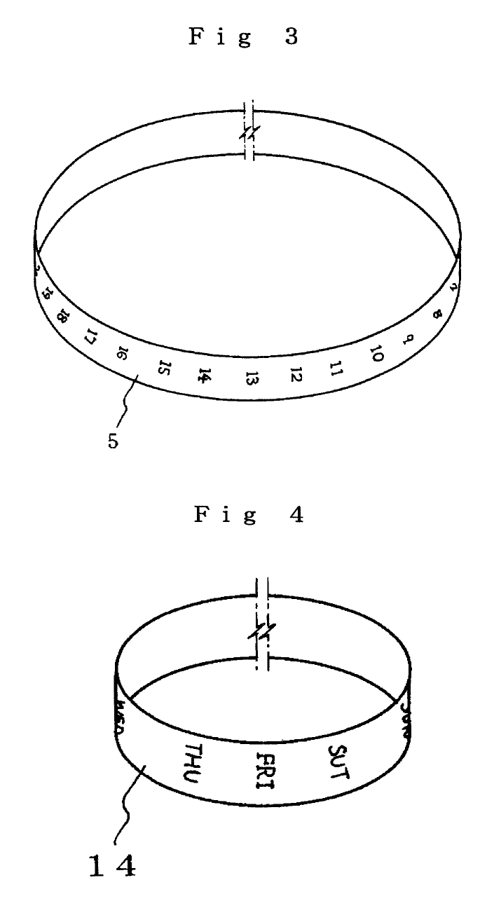

As illustrated in FIG. 3, the date-displaying sheet 5 of a certain width has consecutive one-month dates printed thereon, and further has both ends integrally connected together so as to direct such a printed surface outward, thereby forming an annular endless sheet. Most part of the date-displaying sheet 5 is placed inside the case 6 by being folded several times, and the date-displaying sheet 5 is preferably formed by a synthetic resin material which is free of wrinkles and which has a high level of memory.

As illustrated in FIG. 2, while the majority of the date-displaying sheet 5 is placed and folded several times inside the sheet-receiving case 6, the date-displaying sheet 5 is pulled out of the case 6 through the ejecting opening 10; the pulled sheet 5 is entrained about the pair of sheet guides 11, 11, and is then inserted into the sheet-receiving case 6 in a state of being held between the pair of inserting rollers 8a, 8b.

More specifically, when the roller 8a is turned in the direction of “A”, then the date-displaying sheet 5 held between the rollers 8a, 8b is successively inserted into the sheet-receiving case 6; the date-displaying sheet 5 inside the case 6 is successively folded, while simultaneously being fed out of the case 6 through the ejecting opening 10. As a result, consecutive dates are exposed to outside through the date window 2.

Another pair of sheet guides 11, 11 is mounted on the front plate of the outer case 1 behind the day window 3. The respective sheet guides 11, 11 are positioned at upper and lower positions of the front plate, respectively. A pair of day-displaying sheet-ejecting rollers 12a, 12b as well as a day-displaying sheet-adjusting roller 13 is disposed above the inserting roller 8a, 8b.

A force-inserting band 9 having a certain width is wrapped about the ejecting roller 12b at a substantially central portion thereof. An elastic member such as rubber forms the band 9.

As illustrated in FIG. 4, the day-displaying sheet 14 of a certain width has consecutive one-week days printed thereon, and further has both ends integrally connected together so as to orient such a printed surface outward, thereby formed into an annular endless sheet. A length of the day-displaying sheet 14 is some one-fourth as small as that of the date-displaying sheet 5. As illustrated in FIG. 2, the day-displaying sheet 14 is entrained with tension around the adjusting roller 13 and the pair of sheet guides 11, 11 behind the day window 3, while being held between the ejecting rollers 12a, 12b that are spanned between a pair of side plates of the case 1. Each of the side plates is substantially equal in width to the day-displaying sheet 14. As a result, when the ejecting roller 12a is rotated in the direction of “A”, then the day-displaying sheet 14 is advanced through the ejecting rollers 12a, 12b, thereby exposing consecutive days of the week to the outside through the day window 3.

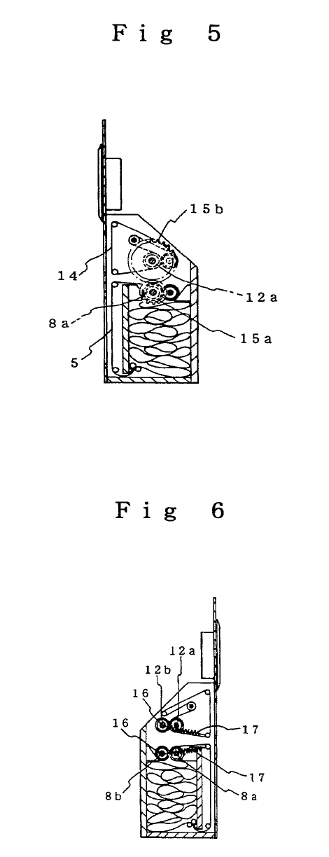

As illustrated in FIG. 5, an interlocking gear 15a is disposed on a shaft of the inserting roller 8a at one end thereof, while another interlocking gear 15b is positioned on a shaft of the ejecting roller 12a at one end thereof. The interlocking gears 15a, 15b are engaged with one another at a gear ratio that synchronously feeds the sheets 5 and 14. As a result, when either the inserting roller 8a or the ejecting roller 12a is rotated, then the sheets 5 and 14 are concurrently fed through the pair of rollers 8a, 8b and through the pair of rollers 12a, 12b, respectively.

As illustrated in FIG. 6, there are one rotatably supporting hole 16 for rotatably supporting a shaft of the inserting roller 8b at one end thereof and another rotatably supporting holes 16 for rotatably supporting a shaft of the ejecting roller 12b at one end thereof. Such a pair of rotatably supporting holes 16, 16 is formed into elliptical shapes toward the inserting roller 8a and the ejecting roller 12a, respectively. This configuration allows the respective shafts of the rollers 8b, 12b to be moved toward the opposite pair of rollers 8a, 12a, respectively. In addition, a pair of tension springs 17 is provided to always impose urging forces on the rollers 8b, 12b in order to force the rollers 8b, 12b toward the opposite rollers 8a, 12a, respectively.

The force-inserting band 9 on the inserting roller 8b at the central portion thereof allows the date-displaying sheet 5 to be held between the rollers 8a, 8b, while the force-inserting band 9 on the ejecting roller 12b at the central portion thereof permits the day-displaying sheet 14 to be held between the rollers 12a, 12b. The rotation of the bands 9, 9 forcedly feeds the sheets 5, 14, respectively.

When the respective shafts of the roller 8b, 12b are moved away from the opposite pair of rollers 8a, 12a against the urging forces of the springs 17, 17, then the sheets 5 and 14 are released from being held between the rollers 8a, 8b and between the rollers 12a, 12b, respectively. Since a month ends at either the thirtieth day or the thirty-first day, there is a difference between days and dates. In order to match the dates with the days, either the sheet 5 or the sheet 14 is released from being held either between the rollers 8a, 8b or between the rollers 12a, 12b, thereby allowing the dates to be coincident with the days.

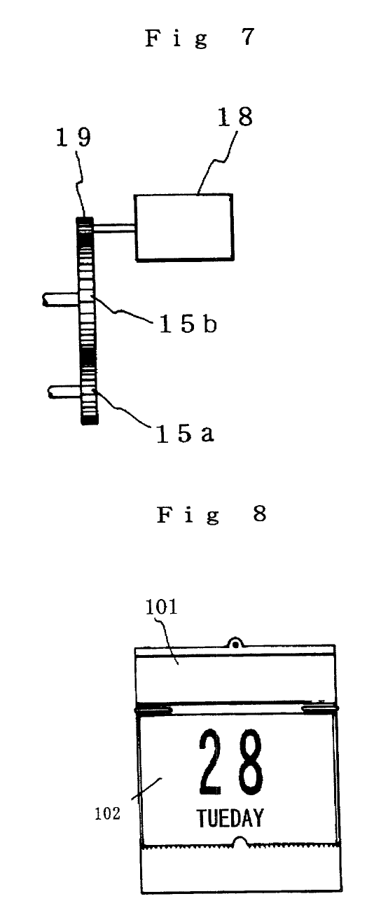

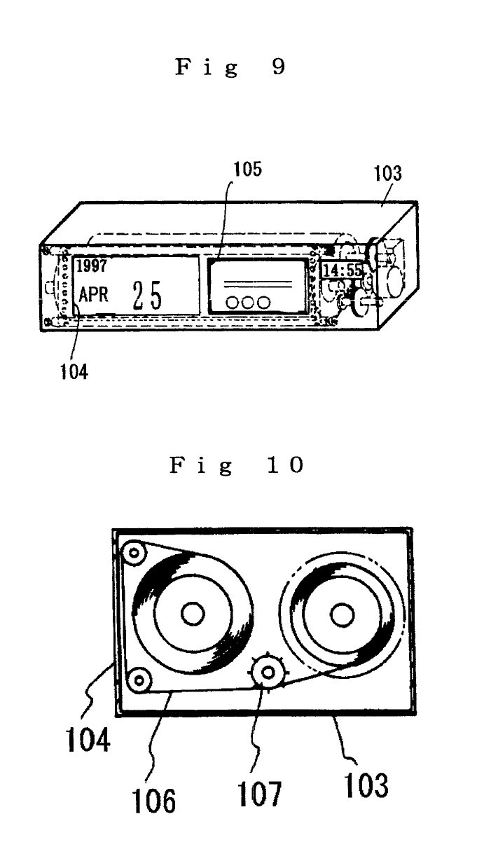

As illustrated in FIG. 7, a driving gear 19 on an electrically driven motor 18 is in mesh with either the interlocking gear 15a on the shaft of the roller 8a or the interlocking gear 15b on the shaft of the roller 12a, and serves as an automatic sheet-feeding means. According to the present embodiment, the driving gear 19 is engaged with the gear 15b. The motor 18 is powered by a battery (not shown).

When the battery-driven timer 4 changes a date, then the motor 18 is automatically switched on, thereby rotating the gear 19. As a result, the gear 15b on the shaft of the ejecting roller 12a is rotated. The rotated gear 15b feeds the sheets 5, 14, thereby changing a date and day, respectively. When the date and day are completely changed, then the motor 18 is automatically switched off.

Although the date window 2, day window 3, and timer 4 are vertically arranged in a row according to the present embodiment, these components may be horizontally aligned with each other.

Pursuant to the present invention, when the timer 4 shows twelve o'clock in the midnight, then the motor 18 is switched on, thereby rotating the rollers 8a, 12a. At that time, the sheets 5, 14 are held between the pair of rollers 8a, 8b and between the pair of rollers 12a, 12b, respectively, while the respective bands 9 on the rollers 8b, 12b press the sheets 5, 14 against the rollers 8a, 12a, respectively. In this state, the sheets 5, 14 are fed to a point where the following date and day are displayed.

The respective bands 9 forcedly feed the sheets 5, 14 by pressing the sheets 5, 14 at respective central portions thereof. At that time, the bands 9 press the sheets 5, 14 only at the respective central portions thereof. This feature eliminates rightward and leftward displacement of the sheets 5, 14 which otherwise would be jammed and stopped.

The sheet-receiving case 6 include no gaps except for the inserting opening 7 between the rollers 8a, 8b and the ejecting opening 10. As a result, the sheet 5 remains folded several times within the case 6 without being allowed to extend outside the case 6.

The pair of side plates restricts both ends of the sheets 5, 14, and the sheet 5, 14 are smoothly fed in sequence without being allowed to move sideward.

The fed sheets 5 and 14 displays the following date and day through the windows 2 and 3, respectively, and then the motor 18 is automatically switched off.

The motor 18 may be switched on and off under the control of any one of various control systems such as a timer control based on the time in which the sheet 5 and 14 are fed to display the following date and day, or alternatively an optical sensor off-control using a light tight mark on either the sheet 5 or the sheet 14. At any rate, the daily calendar according to the present invention preferably employs the most appropriate control system in accordance with situations.

The circulation of the endless sheets 5, 14 containing thirty-one dates in combination with days of the week allows for semi-permanent use of the daily calendar without replacement of the dates and days.

As described above, pursuant to the present invention, a combination of the date-displaying endless sheet containing the thirty-one dates and the day-displaying endless sheet including the days of the week provides a semi-permanently operable daily calendar that is exempted from replacement of date- and day-containing sheets as practiced in the prior art reel-type calendars.

The date- and day-displaying sheets are fed by the respective force-inserting bands having certain widths, not by the respective rollers along the entire surfaces thereof. As a result, the date- and day-displaying sheets can smoothly be fed without incidents such as a paper jam caused by sideward displacement of the sheet.

When the timer displays twelve o'clock in the midnight, then the date- and day-displaying sheets are advanced to automatically expose the following date and day to the outside through the date and day windows, respectively. As a result, the daily calendar according to the present invention ensures accurate date and day displays.

What is claimed is:

1. A daily calendar comprising:
an outer case including one of integrally formed date and day windows and individually formed date and day windows,
the outer case comprising:
a date-displaying endless sheet consecutively containing thirty-one dates in a machine direction of the sheet in order to expose the dates to outside through the date window;
a day-displaying endless sheet consecutively containing days of a week in a machine direction of the sheet in order to expose the days to outside through the day window;
a first pair of rollers for holding the date-displaying sheet therebetween in a cross-machine direction of the sheet; and
a second pair of rollers for holding the day-displaying sheet therebetween in a cross-machine direction of the sheet,
wherein the first pair of rollers is rotated to feed the date-displaying sheet to a point that displays the following date, while the second pair of rollers is rotated to feed the day-displaying sheet to a level that displays the following day of the week.

2. A daily calendar as defined in claim 1, wherein one of the first pair of rollers has a shaft rendered free atone end thereof where a first spring is disposed on the shaft, thereby allowing an urging force of the first spring to hold the date-displaying sheet between the first pair of rollers, while one of the second pair of rollers has a shaft rendered free at one end thereof where a second spring is positioned on the shaft, thereby allowing an urging force of the second spring to hold the day-displaying sheet between the second pair of rollers.

3. A daily calendar as defined in claim 1 or 2, wherein an electrically driven motor with a timer, disposed in the outer case, rotates the first and second pairs of rollers in order to feed the date- and day-displaying sheets to an extent that displays the following date and day, respectively.

4. A daily calendar comprising:
an outer case including one of integrally formed date and day windows and individually formed date and day windows,
the outer case comprising:
a date-displaying endless sheet consecutively containing thirty-one dates in a machine direction of the sheet in order to expose the dates to outside through the date window;
a day-displaying endless sheet consecutively containing days of a week in a machine direction of the sheet in order to expose the days to outside through the day window;
a first pair of rollers for holding the date-displaying sheet therebetween in a cross-machine direction of the sheet; and
a second pair of rollers for holding the day-displaying sheet therebetween in a cross-machine direction of the sheet,
wherein a first force-inserting band having a certain width is wrapped around one of the first pair of rollers at a substantially central portion of the roller, while a second force-inserting band having a certain width is wrapped around one of the second pair of rollers at a substantially central portion of the roller, the first and second force-inserting bands being each made of an elastic material, and wherein the first pair of rollers is rotated to feed the date-displaying sheet to a level that displays the following date, while the second pair of rollers is rotated to feed the day-displaying sheet to an extent that displays the following day of the week.

5. A daily calendar as defined in claim 4, wherein one of the first pair of rollers has a shaft rendered free at one end there of where a first spring is disposed on the shaft, thereby allowing an urging force of the first spring to hold the date-displaying sheet between the first pair of rollers, while one of the second pair of rollers has a shaft rendered free at one end thereof where a second spring is positioned on the shaft, thereby allowing an urging force of the second spring to hold the day-displaying sheet between the second pair of rollers.

6. A daily calendar as defined in claim 4 or 5, wherein an electrically driven motor with a timer, disposed in the outer case, rotates the first and second pairs of rollers in order to feed the date- and day-displaying sheets to a level that displays the following date and day, respectively.
